(19) United States
(12) Patent Application Publication
(10) Pub. No.: US 2015/0273679 A1
(43) Pub. Date: Oct. 1, 2015

(54) PNEUMATIC TOOL

(71) Applicant: BASSO INDUSTRY CORP., Taichung (TW)

(72) Inventors: San-Yih Su, Taichung (TW); Da-Jay Lin, Taichung (TW)

(21) Appl. No.: 14/665,357

(22) Filed: Mar. 23, 2015

(30) Foreign Application Priority Data
Mar. 27, 2014 (TW) 103205292

(51) Int. Cl. B25F 5/00

(52) U.S. Cl. CPC B25F 5/005

(57) ABSTRACT

A pneumatic tool includes a tool body and a driving unit. The tool body has a handle portion having opposite front and rear handle ends along a first axis, and a head portion that is connected to the front handle end of the handle portion, and that has opposite first and second head ends along a second axis perpendicular to the first axis. A ratio of the sum of a width of the head portion along the first axis and a distance between the front and rear handle ends of the handle portion to a distance between the first and second head ends is equal to or greater than 2. The driving unit is mounted in the head portion, and includes a cylinder operated by high pressure air, and a power transmission member driven by the cylinder for power transmission.

### CROSS-REFERENCE TO RELATED APPLICATION

This application claims priority of Taiwanese Application No. 103205292, filed on Mar. 27, 2014.

### FIELD

The disclosure relates to a pneumatic tool, and more particularly to a pneumatic tool with a relatively long handle portion.

### BACKGROUND

Referring to FIG. 1, U.S. Patent Application Publication No. 2013/0233585 discloses a conventional pneumatic tool 1 that includes a handle body 11, a head body 12 connected to a front end portion of the handle body 11, a drive gear unit 13 rotatably disposed in the handle body 11, a hit unit 14 rotatably disposed in the head body 12 for power transmission, and a driven bevel gear 15 meshing with the drive gear unit 13 and coaxially rotatable with the hit unit 14. When the drive gear unit 13 is driven by a power source to rotate the driven bevel gear 15, rotation of the hit unit 14 is actuated.

However, power loss may occur during power transmission from the drive gear unit 13 to the driven bevel gear 15, thereby reducing torque of the hit unit 14. Moreover, according to the structural arrangement of the conventional pneumatic tool 1, abrasions between the components thereof may cause damage to the components and may further cause noise and excess vibration.

Referring to FIG. 2, another conventional pneumatic tool 2 includes a handle body 21, a head body 22 formed at an end portion of the handle body 21, and a drive unit 23 mounted in the head body 22.

Based on the structure of the conventional pneumatic tool 2, the handle body 21 is relatively short, while the head body 22 is relatively large and heavy, with front and rear parts protruding respectively from opposite sides of the end portion of the handle body 21. When a user holds the handle body 21 by one hand, due to the weight of the conventional pneumatic tool 2 being concentrated on the head body 22, operation of the conventional pneumatic tool 2 may be inconvenient.

### SUMMARY

Therefore, an object of the disclosure is to provide a pneumatic tool that can alleviate at least one of the drawbacks of the prior arts.

According to the disclosure, the pneumatic tool includes a tool body and a driving unit.

The tool, body has a handle portion and a head portion. The handle portion extends along a first axis and has front and rear handle ends opposite to each other along the first axis. The head portion is connected to the front handle end of the handle portion, extends along a second axis perpendicular to the first axis, and has first and second head ends opposite to each other along the second axis. A ratio of the sum of a width of the head portion along the first axis and a distance between the front and rear handle ends of the handle portion to a distance between the first and second head ends is equal to or greater than 2.

The driving unit is mounted in the head portion, and includes a cylinder and a power transmission member. The cylinder is adapted to be operated by high pressure air. The power transmission member is driven by the cylinder for power transmission.

### BRIEF DESCRIPTION OF THE DRAWINGS

Other features and advantages of the disclosure will become apparent in the following detailed description of the embodiment with reference to the accompanying drawings, of which:

FIG. 1 is a partly exploded perspective view illustrating a conventional pneumatic tool disclosed in U.S. Patent Application Publication No. 2013/0233585;

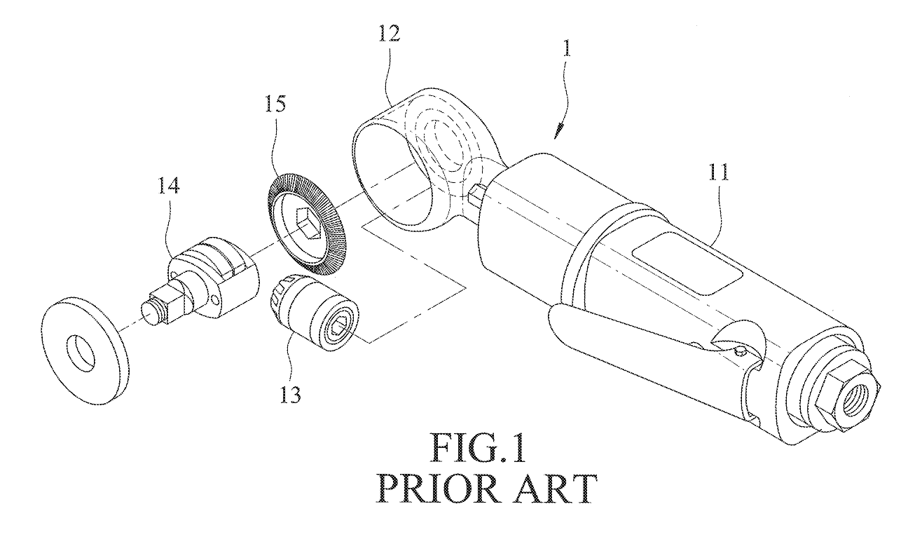

FIG. 2 is a perspective view illustrating another conventional pneumatic tool;

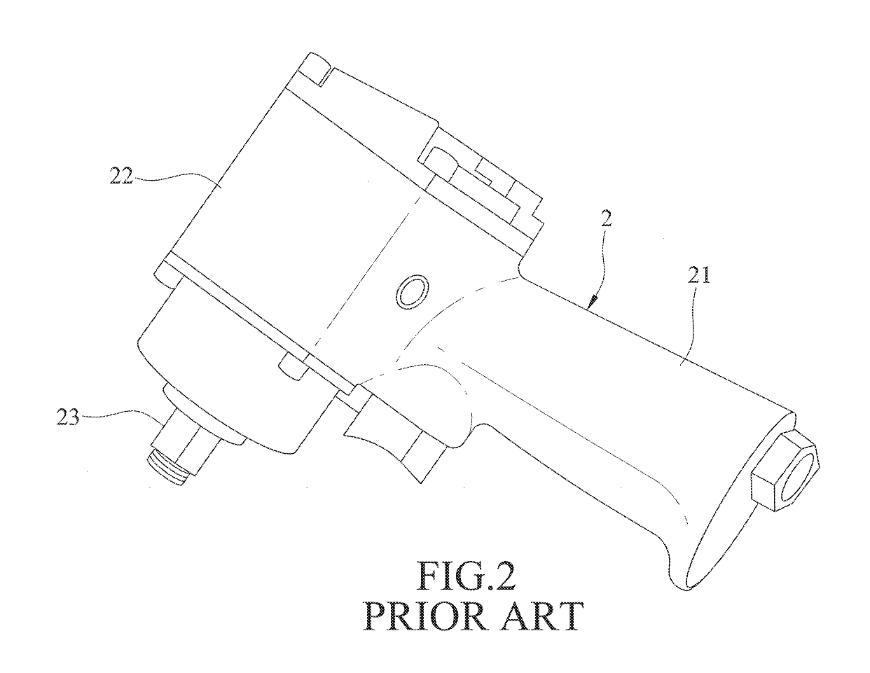

FIG. 3 is a perspective view illustrating an embodiment of a pneumatic tool according to the disclosure; and

FIG. 4 is a partly sectional side view of the embodiment.

### DETAILED DESCRIPTION

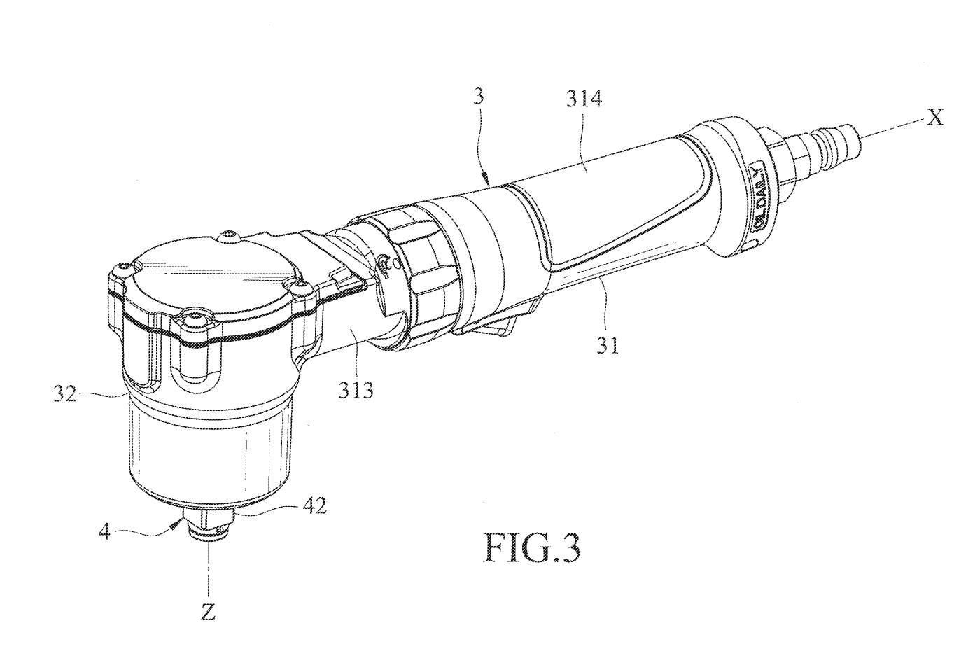

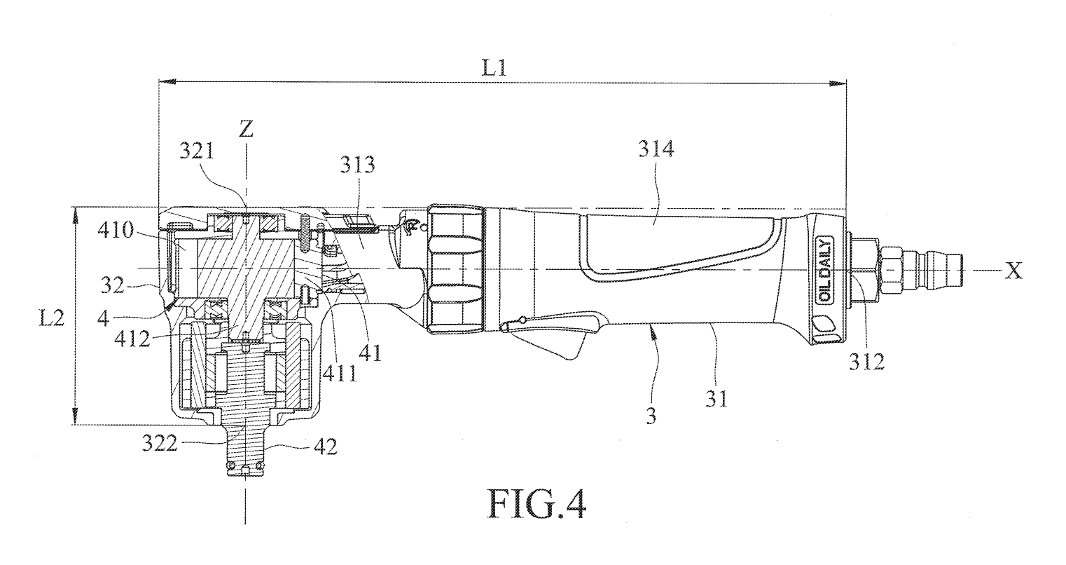

Referring to FIGS. 3 and 4, an embodiment of a pneumatic tool according to the disclosure is illustrated. The pneumatic tool includes a tool body 3 and a driving unit 4.

The tool body 3 has a handle portion 31 and a head portion 32. The handle portion 31 extends along a first axis (X) and has a front handle end and a rear handle end 312 opposite to the front handle end along the first axis (X). The head portion 32 is connected to the front handle end of the handle portion 31, extends along a second axis (Z) perpendicular to the first axis (X) and has first and second head ends 321, 322 opposite to each other along the second axis (Z). In this embodiment, the handle portion 31 further has a connection segment 313 that is connected to the head portion 32 and that has the front handle end of the handle portion 31, and a handle segment 314 that extends from the connection segment 313 along the first axis (X) and that has the rear handle end 312 of the handle portion 31. As shown in FIG. 4, a distance along the second axis (Z) between the first axis (X) and one of the first and second head ends 321, 322 which is proximate to the front handle end of the handle portion 31 is configured to be shorter than a maximum radius of the handle portion 31 in the direction of the second axis (Z). In this embodiment, the distance along the second axis (Z) between the first axis (X) and the first head ends 321 is shorter than the maximum radius of the handle portion 31 in the direction of the second axis (Z). A first length (L1) is defined as the sum of a width of the head portion 32 along the first axis (X) and the distance between the front handle end and the rear handle end 312 of the handle portion 31. A second length (L2) is defined as a distance between the first and second head ends 321, 322. A ratio of the first length (L1) to the second length (L2) is configured to be equal to or greater than 2. In some embodiments of the disclosure, the first length (L1) may range from 230 millimeters to 280 millimeters, and the second length (L2) may range from 58 millimeters to 90 millimeters. Therefore, the ratio of the first length (L1) to the second length (L2) may also range from 3 to 4. For example, when the first length (L1) is 2.50 millimeters and the second length (L2) is 75 millimeters, the ratio of the first length (L1) to the second length (L2) is approximately 3.33.

The driving unit 4 is mounted in the head portion 32, and includes a cylinder 41 and a power transmission member 42. The cylinder 41 is adapted to be operated by high pressure air. The power transmission member 42 is driven by the cylinder 41 for power transmission. In this embodiment, the cylinder 41 has a cylinder wall 411 that defines an air space 410, and a rotor 412 that is rotatably disposed within The air space 410. The power transmission member 42 extends along the second axis (Z) and is co-rotatably connected to the rotor 412.

When the high pressure air enters into the air space 410 to drive rotation of the rotor 412, the power transmission member 42 is actuated to rotate.

By virtue of the specific ratio between the first length (L1) to the second length (L2), the handle portion 31 is lengthened, enhancing gripping comfort of the handle segment 314 in an ergonomic manner.

To sum up, the pneumatic tool according to the disclosure can achieve the following advantages.

1. Since the cylinder 41 directly drives operation of the power transmission member 42 without intermediate components, the power transmission member 42 can have enhanced power transmission efficiency. In addition, by such structural arrangement of the cylinder 41 and the power transmission member 42, noise and vibration can be reduced. As a result, components of the driving unit 4 can have a longer service life.

2. By virtue of the abovementioned configuration of the tool body 3, the pneumatic tool according to the disclosure is easy to grip and may be conveniently operated or stored in a small space.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A pneumatic tool comprising:
a tool body having
a handle portion that extends along a first axis and that has a front handle end and a rear handle end opposite to said first front handle end along the first axis, and
a head portion that is connected to said front handle end of said handle portion, that extends along a second axis perpendicular to the first axis, and that has first and second head ends opposite to each other along the second axis, a ratio of the sum of a width of said head portion along the first axis and a distance between said front and rear handle ends of said handle portion to a distance between said first and second head ends being equal to or greater than 2; and
a driving unit mounted in said head portion and including
a cylinder that is adapted to be operated by high pressure air, and
a power transmission member that is driven by said cylinder for power transmission.

2. The pneumatic tool as claimed in claim 1, wherein the sum of the width of said head portion along the first axis and the distance between said front handle end and said rear handle end of said handle portion ranges from 230 millimeters to 280 millimeters.

3. The pneumatic tool as claimed in claim 1, wherein the distance between said first and second head ends ranges from 50 millimeters to 90 millimeters.

4. The pneumatic tool as claimed in claim 1, wherein a distance along the second axis between the first axis and one of said first and second head ends which is proximate to said front handle end of said handle portion is shorter than a maximum radius of said handle portion in the direction of the second axis.

5. The pneumatic tool as claimed in claim 1, wherein said handle portion further has a connection segment that is connected to said head portion and that has said front handle end, and a handle segment that extends from said connection segment along the first axis and that has said rear handle end.

6. The pneumatic tool as claimed in claim 1, wherein said cylinder has a cylinder wall that defines an air space, and a rotor that is rotatably disposed within said air space, said power transmission member extending along the second axis and being co-rotatably connected to said rotor.

7. The pneumatic tool as claimed in claim 1, wherein the ratio of the sum of the width of said head portion along the first axis and the distance between said front handle end and said rear handle end of said handle portion to the distance between said first and second head ends ranges from 3 to 4.
